(19) United States
(12) Patent Application Publication
(10) Pub. No.: US 2002/0158840 A1
(43) Pub. Date: Oct. 31, 2002

(54) Coordinate input device having reduced number of components, being easy to assemble, and including deformation detecting elements

(75) Inventor: Shinji Hirano, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/133,099

(22) Filed: Apr. 26, 2002

(30) Foreign Application Priority Data
Apr. 27, 2001 (JP) 2001-131306

(51) Int. Cl. G09G 5/00

(52) U.S. Cl. 345/156; 345/160

(57) ABSTRACT

A coordinate input device includes a columnar operation member and a printed circuit board to which the operation member is mounted on a major surface thereof. The printed circuit board includes a deformation part which can be deformed when the operation member is tilted or depressed. Deformation detecting elements disposed on one major surface or the other major surface of the deformation part determine the amount of deformation of the deformation part. A substrate such as used in a known coordinate input device is eliminated from the operation member so that the number of components is reduced and the coordinate input device is easily manufactured.

### BACKGROUND OF THE INVENTION

1. Field of the Invention

The present invention relates to a coordinate input device using deformation detecting elements. The coordinate input device is used for computers and the like and is capable of being surface-mounted.

2. Description of the Related Art

FIG. 8 shows a known coordinate input device. In FIG. 8, a printed circuit board 51 is provided with a plurality of wiring patterns (not shown) on a surface thereof.

Four pairs of lands 51a, each land 51a of the pair opposing the other land 51a, are formed toward one end of the printed circuit board 51. An operation unit 52 is fixed to the lands 51a by soldering.

The operation unit 52 includes a flat rectangular substrate 53 and an operation member 54 bonded to the substrate 53 via an adhesive or the like. The substrate 53 is provided with a plurality of deformation detecting elements (for example, four deformation detecting elements not shown) on the surface of the substrate 53 opposing the printed circuit board 51.

The deformation detecting elements are made of a resistive material. The deformation detecting elements are disposed at a certain distance from each other along diagonal lines of the substrate 53.

Patterns (not shown) are led from the deformation detecting elements and are connected to electrodes (not shown) formed at the corners of the rectangular substrate 53. The electrodes are connected to the lands 51a of the printed circuit board 51; thus, the operation unit 52 is mounted to the printed circuit board 51.

A given gap is produced between the substrate 53 and the deformation detecting elements when the printed circuit board 51 is surface-mounted.

The square-columnar operation member 54 is bonded to the other surface of the substrate 53 at a central part thereof by an adhesive or the like.

The known coordinate input device is formed such that the operation member 54 is bonded to the central part of the substrate 53 by an adhesive so as to form the operation unit 52, and a cream solder is applied to the lands 51a of the printed circuit board 51.

The electrodes formed on the surface of the substrate 53 are positioned on the lands 51a, thereby placing the operation unit 52 on the lands 51a.

The printed circuit board 51 including the operation unit 52 passes through a high-temperature solder furnace, whereby the operation unit 52 is surface-mounted on the printed circuit board 51 to form the known coordinate input device.

The operation of the coordinate input device is described below. When the operation member 54 tilts with an operating load horizontally applied to the operation member 54 in a direction A, the substrate 53 is deformed as the operation member 54 tilts.

With the deformation of the substrate 53, the resistance value of the deformation detecting elements (not shown) made of a resistive material varies, and the varying resistance value is outputted.

Then, a controller (not shown) determines the amount of variation of the resistance value outputted from each of the plurality (for example, four) of deformation detecting elements, and controls the movement of a cursor in a display of, for example, a personal computer in accordance with the amount of variation of the resistance value.

However, a problem has been found in that the assembly process to form the known coordinate input device is complex and the formation thereof thereby takes a long time. In this process the deformation detecting elements are print-formed on the substrate 53, the operation unit 52 is formed by bonding the operation member 54 to the substrate 53 by an adhesive, and the operation unit 52 is fixed to the lands 51a of the printed circuit board 51 by soldering.

### SUMMARY OF THE INVENTION

Accordingly, it is an object of the present invention to provide a coordinate input device having a reduced number of components and easy to manufacture.

To this end, according to an aspect of the present invention, a coordinate input device comprises a columnar operation member; a printed circuit board which is provided with the operation member mounted to one major surface thereof and which includes a deformation part which is deformable when the operation member is tilted or depressed; and at least one deformation detecting element provided on the deformation part, for determining the amount of deformation of the deformation part.

In the coordinate input device according to the present invention, the at least one deformation detecting element may comprise at least four deformation detecting elements disposed ninety degrees apart between each other around the operation member. The deformation part may include a plurality of beams defined by a plurality of through-holes, each through-hole being formed between the deformation detecting elements. One deformation detecting element may be provided on each beam.

The plurality of beams may comprise at least four beams which are defined by the plurality of through-holes so as to be formed as a cross, the beams being disposed ninety degrees apart between each other around the operation member.

Each deformation detecting,element may comprise a resistive material which is formed directly on either one major surface or the other major surface of each beam in the vicinity of the operation member.

The printed circuit board may comprise a ceramic material such as alumina. The deformation detecting element may comprise a resistive cermet.

The deformation detecting element may comprise a chip-type deformation sensor which is surface-mounted to either one major surface or the other major surface of each beam in the vicinity of the operation member.

The through-holes may comprise either slits or angular holes, each slit or angular hole being formed between the adjacent beams.

The deformation part may be formed of a part of the printed circuit board at which a recess is formed and the thickness of the printed circuit board is thereby reduced, the recess being formed either in the one major surface or in the other major surface of the printed circuit board. The operation member may be mounted to the center of the part at which the thickness of the printed circuit board is reduced. The at least one deformation detecting element may comprise at least four deformation detecting elements disposed on the deformation part ninety degrees apart between each other around the operation unit.

The deformation detecting elements may comprise resistive materials formed directly on or chip-type deformation sensors surface-mounted to either the one major surface or the other major surface of the part of the printer circuit board at which the thickness thereof is reduced.

According to the present invention, the deformation of the deformation part of the printed circuit board is detected by at least one deformation detecting element disposed on the deformation part, whereby the operation member can be formed only of a square-columnar member, thereby reducing the number of components and the time required for assembly.

When the deformation part includes a plurality of beams which are defined by a plurality of through-holes formed between the deformation detecting elements which are disposed on the beams, the deformation part can be easily deformed with the operation member being tilted or depressed, thereby providing a coordinate input device which can be easily operated with a small operational force.

The strength of the portion of the printed circuit board other than deformation part is not reduced, whereby the performance of the printed circuit board is not reduced.

When at least four beams, which are formed as a cross, are provided around the operation member 90 degrees apart between each beam by being defined by the through-holes, the beams can be easily deformed with a small operational force.

When each deformation detecting element includes a resistive material and is mounted directly to one major surface or the other major surface of each beam disposed in the vicinity of the operation member, the deformation detecting elements can be reliably deformed, thereby accurately varying the resistance.

When the printed circuit board is made of a ceramic material such as alumina and each deformation detecting element is made of a resistive cermet, a coordinate input device can be obtained, in which variation in the resistance value according to the variation in temperature is reduced and which has excellent temperature characteristics.

When each deformation detecting element includes a chip-type deformation sensor surface-mounted to one major surface or the other major surface of each beam disposed in the vicinity of the operation member, it is not necessary to form resistive materials on the printed circuit board by printing, sputtering, or the like, whereby the printed circuit board can be easily manufactured.

When each through-hole includes a slit or a triangular hole which is formed between the adjacent beams, the beams can be deformed with a small force. The through-holes can be easily formed by pressing, laser cutting, or the like.

When the deformation part is provided with a recess formed in one major surface and/or the other major surface of the printed circuit board, the thickness of the printed circuit board is thereby reduced at the deformation part thereof, the operation member is mounted to the center of the thin deformation part, and at least four deformation detecting elements are disposed 90 degrees apart between each other around the operation member, sufficient area of the deformation part to mount the deformation detecting elements can be ensured by forming the deformation part being reduced in thickness by being provided with the recess therein instead of being provided with through-holes. Therefore, the size of the deformation detecting elements can be increased, whereby a coordinate input device which can accurately detect deformation is provided.

When the deformation detecting elements include resistive materials directly mounted to or chip-type deformation sensors surface-mounted to one major surface or the other major surface of the deformation part in the vicinity of the operation member, whose thickness is reduced, the size of the deformation detecting elements can be increased.

### BRIEF DESCRIPTION OF THE DRAWINGS

FIG. 1 is a top plan view of a coordinate input device according to an embodiment of the present invention;

FIG. 2 is a perspective view of the coordinate input device shown in FIG. 1;

FIG. 3 is a sectional view along line III-III of the coordinate input device shown in FIG. 1;

FIGS. 4A and 4B are schematic views showing the operation of the coordinate input device according to the embodiment of the present invention;

FIG. 5 is an exploded perspective view of a coordinate input device according to another embodiment of the present invention;

FIG. 6 is a perspective view of the coordinate input device shown in FIG. 5;

FIG. 7 is a schematic view of a coordinate input device according to another embodiment of the present invention; and

FIG. 8 is a perspective view of a known coordinate input device.

### DESCRIPTION OF THE PREFERRED EMBODIMENTS

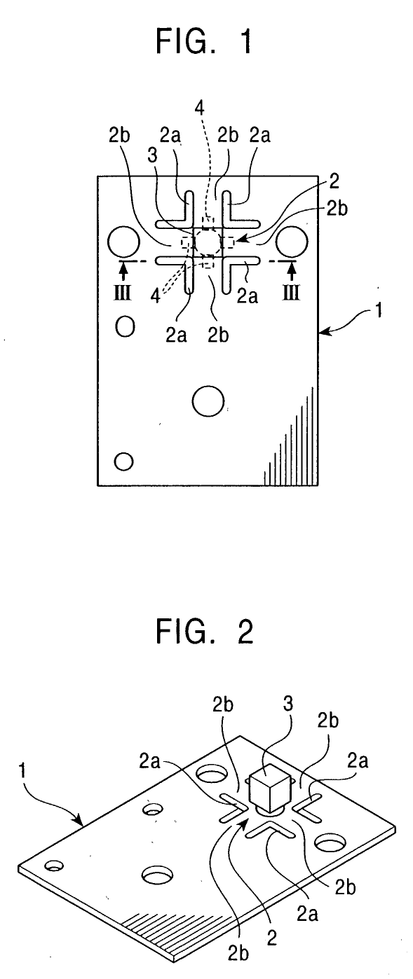

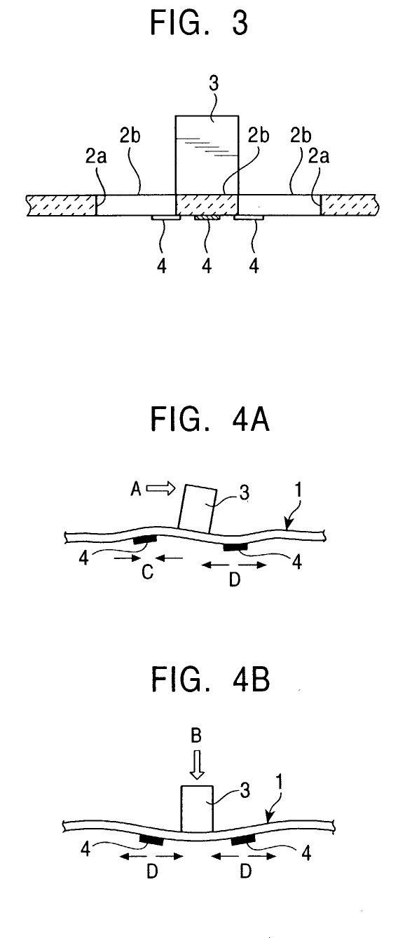

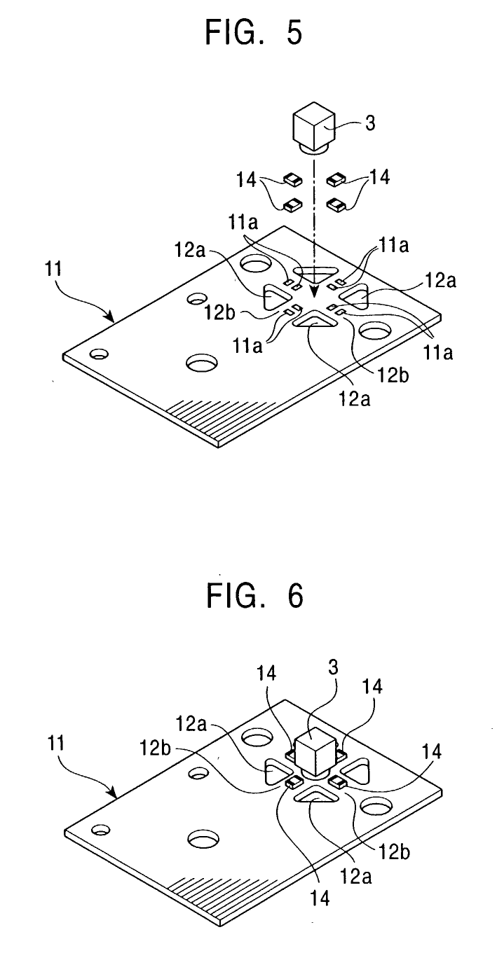

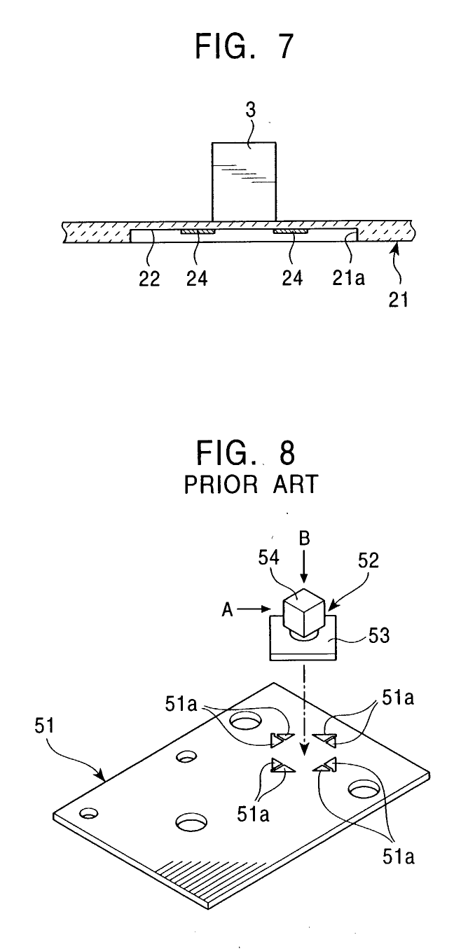

A coordinate input device according to embodiments of the present invention is described below with reference to the drawings. FIG. 1 is a top plan view of a coordinate input device according to an embodiment of the present invention. FIG. 2 is a perspective view of the coordinate input device shown in FIG. 1. FIG. 3 is a sectional view along line III-III of the coordinate input device shown in FIG. 1. FIGS. 4A and 4B are schematic views showing the operation of the coordinate input device according to the embodiment of the present invention. FIGS. 5 to 7 are illustrations of a coordinate input device according to other embodiments of the present invention.

The coordinate input device according to the present invention serves to move a cursor in a display of, for example, a personal computer to a given position with the operation of the coordinate input device according to the present invention, the coordinate input device being mounted to a keyboard of the personal computer.

A coordinate input device according to an embodiment of the present invention is described below with reference to FIGS. 1 to 3. A printed circuit board 1 is mounted in a keyboard (not shown) of a personal computer or the like.

The printed circuit board 1 is made of a material having excellent temperature characteristics, such as an epoxy resin containing glass or a ceramic material including alumina or the like.

The printed circuit board 1 includes a deformation part 2 at a part of the printed circuit board 1. The deformation part 2 is formed as a cross including four mutually orthogonal beams 2b, which are defined by slit through-holes 2a each in an L-shape and which extend from a center of the deformation part 2. An operation member 3 is disposed at the center of the deformation part 2.

The shape of the through-holes 2a is not limited to a slit. The through-holes 2a may be, for example, triangular, like through-holes 12a shown in FIG. 5, which are described below.

The operation member 3, which has a square-columnar shape, is mounted perpendicular to the surface of the printed circuit board 1 at the center of the deformation part 2 from which the four beams 2b extend, the operation member 3 being bonded to the printed circuit board 1 by an adhesive (not shown) made of a thermosetting resin such as an epoxy. The operation member 3 is made of a ceramic material such as alumina, has excellent temperature characteristics, and is hard, whereby the operation member 3 can properly transfer the force applied thereto to the deformation part 2.

The square-columnar operation member 3 is covered with, for example, a nonwoven fabric cap (not shown), whereby a user can easily manipulate the operation member 3 with a finger.

The beams 2b of the printed circuit board 1 can be deformed with the operation member 3 being tilted or depressed.

Deformation detecting elements 4 made of a resistive cermet are formed at the lower surface of the deformation part 2 by printing or sputtering. The variation of resistance of the deformation detecting elements 4 is controlled so as to be within a predetermined range by laser trimming or photolithography.

In FIG. 3, the four deformation detecting elements 4 are disposed on the lower surface of the beams 2b in the vicinity of the operation member 3, of which a detailed description is provided below, an angle of 90 degrees apart between each other around the operation member 3.

When the operation member 3 tilts or is depressed and the deformation part 2 is thereby deformed, the resistance value of each deformation-detecting element 4 varies.

The deformation detecting elements 4 may be disposed at the upper surface of the printed circuit board 1 at which the operation member 3 is mounted, instead of the lower surface of the printed circuit board 1.

The operation of the coordinate input device according to the present invention is described below. Firstly, a load is applied to the operation member 3 in a horizontal direction A, thereby tilting the operation member 3 to the right, as shown in FIG. 4A.

Then, the deformation part 2 of the printed circuit board 1 is deformed into a wave shape, and the deformation detecting element 4 at the right side in the drawing is compressed in directions shown by arrows C, whereby the resistance of this deformation detecting element 4 is reduced from an initial value.

In this case, the deformation detecting element 4 at the left side in the drawing is expanded in directions shown by arrows D, whereby the resistance of this deformation detecting element 4 is increased from an initial value.

A controller (not shown) including semiconductors determines and computes the amounts of variation in the resistances of the deformation detecting elements 4, and controls the movement of a cursor in a display of a personal computer or the like in accordance with the amounts of variation of the resistances.

In FIG. 4B, when a load is applied to the operation member 3 in a vertical direction B, the four deformation detecting elements 4 are individually expanded uniformly in directions shown by arrows D, whereby the resistances of the four deformation detecting elements 4 are increased from their initial values.

The controller determines that the resistances of the four deformation detecting elements 4 have been increased, thereby entering a setting mode or a canceling mode with the cursor being disposed at a given position.

Since the square-columnar operation member 3 is mounted directly to the printed circuit board 1 of the coordinate input device according to the present invention, the substrate 53 of the operation member 52 which is used in the known coordinate input device is not necessary, whereby the number of components can be reduced and the assembly becomes easy.

Although according to the present embodiment, the deformation detecting elements 4 are individually fixed to the four beams 2b formed in a cross-shape having an angle of 90 degrees between each other, six deformation detecting elements 4 may be fixed to, for example, six beams 2b (not shown) which are formed so as to have an angle of 60 degrees between each other with respect to the center of the operation member 3.

By increasing the number of deformation detecting elements, the tilting direction of the operation member 3 can be detected more accurately.

Although according to the embodiment of the present invention, the deformation detecting elements 4 are made of a resistive cermet, and are disposed on the lower or upper surface of the printed circuit device 1, chip-type deformation detecting elements 14 shown in FIGS. 5 and 6, which include chip-type deformation sensors, may be surface-mounted on a printed circuit board 11.

The printed circuit board. 11 mounted with the chip-type deformation detecting elements 14 is provided with through-holes 12a which are, for example, triangular. A land 11a is formed on each beam 12b disposed between the through-holes 12a.

The deformation detecting elements 14 are mounted such that electrodes (not shown) of the deformation detecting elements 14 are surface-mounted on the lands 11a.

The deformation detecting elements 14 may be fixed to either the lower surfaces or the upper surfaces of the beams 12b in the vicinity of an operation member 3.

According to another embodiment of the present invention, a deformation part 22 of a printed circuit board 21 is provided with a recess 21a formed in the lower surface of the printed circuit board 21, whereby the thickness of the printed circuit board 21 is reduced to a predetermined value at the deformation part 22. An operation member 3 is mounted to a center of the deformation part 22, where the thickness of the printed circuit board 21 is reduced. At least four deformation detecting elements 24 are disposed on the deformation part 22 90 degrees apart between each other around the operation member 3.

Since the deformation part 22 of the coordinate input device according to the embodiment of the present invention is formed with a thin-walled part having a significantly large area, the size of the deformation detecting elements 24 can be increased, whereby the deformation of the deformation part 22 can be detected accurately.

The position of the recess 21a of the deformation part 22 is not limited to the lower surface of the printed circuit board 21. The recess 21a may be formed in the upper surface of the printed circuit board 21, or two recesses (not shown) may be individually formed in the upper and lower surfaces of the printed circuit board 21, as long as the deformation part 22 can be reduced in thickness.

That is, the deformation part 22 is formed to be thinner with the recess 21a being provided in the lower surface and/or upper surface of the printed circuit board 21.

The deformation detecting elements 24 may include either a resistive material to be directly printed on the lower or upper surface of the thin deformation part 22 or chip-type deformation sensor (not shown) to be surface-mounted to the lower or upper surface of the thin deformation part 22.

What is claimed is:

1. A coordinate input device comprising:
a columnar operation member;
a printed circuit board which is provided with the operation member mounted to one major surface thereof and which includes a deformation part which is deformable when the operation member is tilted or depressed; and
at least one deformation detecting element provided on the deformation part, for determining the amount of deformation of the deformation part.

2. A coordinate input device according to claim 1, wherein the at least one deformation detecting element comprises at least four deformation detecting elements disposed ninety degrees apart between each other around the operation member, the deformation part includes a plurality of beams defined by a plurality of through-holes, each through-hole being formed between the deformation detecting elements, and one deformation detecting element is provided on each beam.

3. A coordinate input device according to claim 2, wherein the plurality of beams comprises at least four beams which are defined by the plurality of through-holes so as to be formed as a cross, the beams being disposed ninety degrees apart between each other around the operation member.

4. A coordinate input device according to claim 2, wherein each deformation detecting element comprises a resistive material which is formed directly on either one major surface or the other major surface of each beam in the vicinity of the operation member.

5. A coordinate input device according to claim 1, whereby the printed circuit board comprises a ceramic material such as alumina, and the deformation detecting element comprises a resistive cermet.

6. A coordinate input device according to claim 1, wherein the deformation detecting element comprises a chip-type deformation sensor which is surface-mounted to either one major surface or the other major surface of each beam in the vicinity of the operation member.

7. A coordinate input device according to claim 2, wherein the through-holes comprise either slits or angular holes, each slit or angular hole being formed between the adjacent beams.

8. A coordinate input device according to claim 1, wherein the deformation part is formed of a part of the printed circuit board at which a recess is formed and the thickness of the printed circuit board is thereby reduced, the recess being formed either in the one major surface or in the other major surface of the printed circuit board, the operation member is mounted to the center of the part at which the thickness of the printed circuit board is reduced, and the at least one deformation detecting element comprises at least four deformation detecting elements disposed on the deformation part ninety degrees apart between each other around the operation unit.

9. A coordinate input device according to claim 8, wherein the deformation detecting elements comprise resistive materials formed directly on or chip-type deformation sensors surface-mounted to either the one major surface or the other major surface of the part of the printer circuit board at which the thickness thereof is reduced.
